(19) United States
(12) Patent Application Publication
(10) Pub. No.: US 2022/0060910 A1
(43) Pub. Date: Feb. 24, 2022

(54) DEPLOYMENT METHOD AND SYSTEM FOR WIRELESS SENSING APPARATUS

(71) Applicant: CARRIER CORPORATION, PALM BEACH GARDENS, FL (US)

(72) Inventors: Jun Hou, Shanghai (CN); Zhen Jia, Shanghai (CN); Jie Xi, Shanghai (CN); Junyang Lin, Shanghai (CN); Yuanjing Sun, Shanghai (CN); Tianyuan Chen, Shanghai (CN)

(21) Appl. No.: 17/251,983

(22) PCT Filed: May 8, 2020
(86) PCT No.: PCT/US2020/032030

§ 371 Date: Dec. 14, 2020

(30) Foreign Application Priority Data
May 16, 2019 (CN) 201910405853.6

(51) Int. Cl. H04W 16/20; H04W 24/08; H04W 4/021; H04W 4/38; H04W 4/33; G06N 3/08

(52) U.S. Cl. CPC H04W 16/20; H04W 24/08; H04W 4/021; H04W 84/12; H04W 4/33; G06N 3/08; H04W 4/38

(57) ABSTRACT

A deployment method and deployment system for a wireless sensing device. The deployment method for a wireless sensing device includes S1: obtaining spatial structure information of a region to be deployed; S2: calculating a layout of the wireless sensing device; S3: calculating a signal strength according to the layout, and judging whether the signal strength meets requirements; S4: judging whether a default neural network model meets the requirements according to signals received by the wireless sensing device; if the requirements are not met, optimizing a pre-trained neural network model through transfer learning according to the signals received by the wireless sensing device; and S5: deploying the optimized neural network model into the wireless sensing device.

### FIELD OF THE INVENTION

The present application relates to deployment and application of wireless sensing devices. More specifically, the present application relates to a deployment method for a wireless sensing device, which aims to improve the deployment efficiency of the wireless sensing device through transfer learning. The present application also relates to a deployment system for a wireless sensing device.

### BACKGROUND OF THE INVENTION

With the continuous improvement of smart building construction and operation technologies, more and more smart building systems need to sense the presence of persons in the building and the types of the persons' activities in real time. A typical wireless sensing device detects the presence of a person in a certain region-of-interest (ROI) through fluctuations within indoor wireless network signals or Wi-Fi signals, and can sense a person's action status through fluctuation type and characteristics of the wireless network signals. This type of wireless sensing device can sense wireless signals by deploying one or more Channel State Information (CSI) transmitters and sensors.

However, during the deployment of existing wireless sensing devices, it is usually necessary to adopt a neural network to learn the correlation between a person's activities in the region-of-interest and wireless signals. Pre-trained models used by the neural network often cannot adapt to the complex environment of actual buildings. In order that the models can achieve the desired performance, it is often necessary to retrain or fine-tune the models according to the actual environment. This requires collecting a lot of on-site data and long-time training. In addition, operations of deploying, commissioning and adjusting the transmitters and sensors need to take a large amount of working hours.

Therefore, there is an ongoing need in the art for an improved deployment method and deployment system for a wireless sensing device, and it is desirable that new solutions can reduce deployment time and improve deployment accuracy.

### SUMMARY OF THE INVENTION

An object of one aspect of the present application is to provide a deployment method for a wireless sensing device, which aims to improve the efficiency and automation degree of the deployment operation for the wireless sensing device. The object of another aspect of the present application is to provide a deployment system for a wireless sensing device.

The objects of the present application are achieved by the following technical solutions:

A deployment method for a wireless sensing device, which includes the following steps:

S1: obtaining spatial structure information of a region to be deployed;

S2: calculating a layout of the wireless sensing device;

S3: calculating a signal strength according to the layout, and judging whether the signal strength meets requirements;

S4: judging whether a default neural network model meets the requirements according to signals received by the wireless sensing device; and if the requirements are not met, optimizing a pre-trained neural network model through transfer learning according to the signals received by the wireless sensing device; and

S5: deploying the optimized neural network model into the wireless sensing device.

In the above deployment method, optionally, in step S1, the spatial structure information of the region to be deployed is obtained from a BIM model or building structure data software.

In the above deployment method, optionally, the wireless sensing device includes a transmitter and a receiver; and in step S2, the layout of the wireless sensing device includes a position of the transmitter, a position of the receiver, and a position of a region-of-interest.

In the above deployment method, optionally, in step S3, a wireless signal strength in the region-of-interest is calculated according to a calculating model and the positions of the transmitter and the receiver.

In the above deployment method, optionally, in step S4, the neural network model includes a convolutional neural network model for detecting a person's activities based on Wi-Fi signals, and signal characteristics received by the wireless sensing device are used as an input in the optimization of the convolutional neural network model.

In the above deployment method, optionally, in step S5, the method further includes storing the optimized neural network model in a database.

In the above deployment method, optionally, each step is executed by one of the following platforms: a server, a receiver of the wireless sensing device, and a handheld device.

A deployment system for a wireless sensing device, which includes: a spatial structure information obtaining module configured to obtain spatial structure information of a region to be deployed;

a wireless sensing device calculating module configured to calculate a layout of the wireless sensing device;

a signal strength planning module configured to calculate a signal strength according to the layout, and judge whether the signal strength meets requirements;

a model optimizing module configured to judge whether a default neural network model meets the requirements according to signals received by the wireless sensing device; and if the requirements are not met, optimize a pre-trained neural network model through transfer learning according to the signals received by the wireless sensing device; and

a deploying module configured to deploy the optimized neural network model into the wireless sensing device.

In the above deployment system, optionally, the spatial structure information obtaining module is configured to obtain the spatial structure information of the region to be deployed from a BIM model or building structure data software.

In the above deployment system, optionally, the wireless sensing device includes a transmitter and a receiver, and calculating the layout of the wireless sensing device includes: setting and/or calculating a position of the transmitter, a position of a region-of-interest, and a position of the receiver.

In the above deployment system, optionally, calculating the signal strength includes calculating a wireless signal strength in the region-of-interest according to a calculating model and the positions of the transmitter and the receiver.

In the above deployment system, optionally, the model optimizing module is further configured to test on-site data from the wireless sensing device according to the default neural network model.

In the above deployment system, optionally, the neural network model includes a convolutional neural network model that detects a person's activities based on Wi-Fi signals, and signal characteristics received by the wireless sensing device are used as an input in the optimization of the convolutional neural network model.

In the above deployment system, optionally, the deploying module is further configured to store the optimized neural network model in a database.

In the above deployment system, optionally, the spatial structure information obtaining module, the wireless sensing device calculating module, the signal strength planning module, the model optimizing module, and the deploying module are deployed on one or more of the followings: a server, a receiver of the wireless sensing device, and a handheld device.

The deployment method and deployment system for a wireless sensing device of the present application have the advantages of simple in structure, convenience in usage, and high operating efficiency, etc. By applying the deployment method and deployment system for a wireless sensing device of the present application, rapid deployment and automatic configuration of the wireless sensing device can be achieved, thereby effectively improving deployment efficiency and reducing deployment cost.

### BRIEF DESCRIPTION OF THE DRAWINGS

The present application will be described below in further detail with reference to the accompanying drawings and preferred embodiments, but those skilled in the art will appreciate that these drawings are drawn only for the purpose of explaining the preferred embodiments and should not be construed as limiting the scope of the present application. In addition, unless specifically stated, the drawings are only intended to conceptually represent the composition or construction of the described objects and may contain exaggerated illustration, and the drawings are not necessarily drawn to scale.

FIG. 1 is a schematic structural view of a wireless sensing device.

FIG. 2 is a schematic structural view of an embodiment of a deployment system for a wireless sensing device according to the present application when used in combination with the wireless sensing device shown in FIG. 1.

FIG. 3 is a flowchart of an embodiment of a deployment method for a wireless sensing device according to the present application.

### DETAILED DESCRIPTION OF THE EMBODIMENT(S) OF THE INVENTION

Hereinafter, preferred embodiments of the present application will be described in detail with reference to the accompanying drawings. Those skilled in the art will appreciate that these descriptions are merely illustrative and exemplary, and should not be construed as limiting the scope of protection of the present application.

Firstly, it should be noted that the terms such as top, bottom, upward, and downward mentioned herein are defined with respect to the directions in various drawings, they are relative concepts, and therefore can be changed according to different positions and different states of use. Accordingly, these or other terms should not be interpreted as restrictive terms.

In addition, it should also be noted that for any single technical feature described or implied in the embodiments herein, or any single technical feature shown or implied in the drawings, it is still possible to combine these technical features (or their equivalents) so as to obtain other embodiments of the present application that are not directly mentioned herein.

It should be noted that in different drawings, identical or substantially identical components are denoted by identical reference signs.

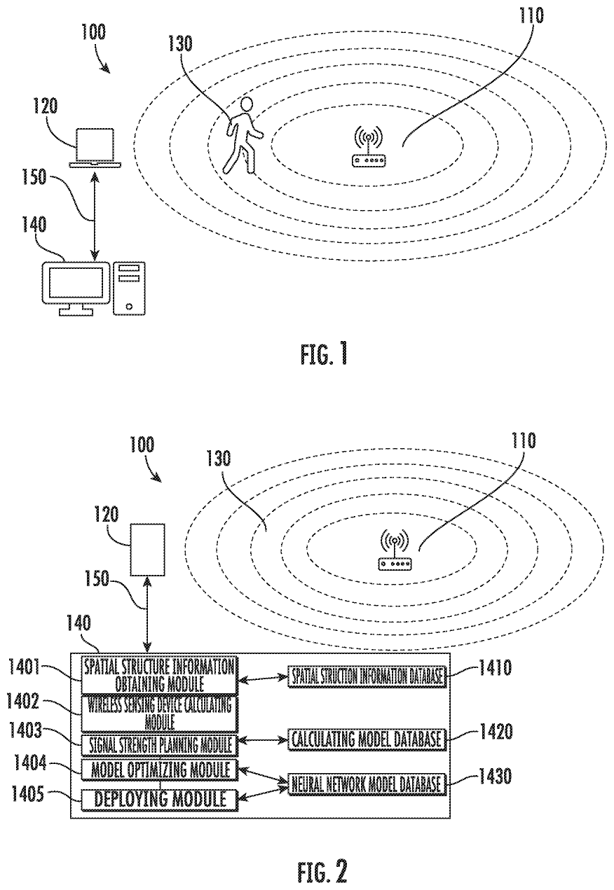

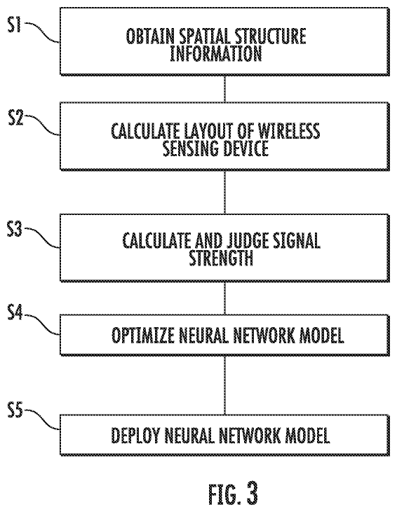

FIG. 1 is a schematic structural view of a wireless sensing device. FIG. 1 illustrates a typical wireless sensing device 100 including a transmitter 110 and a receiver 120. The transmitter 110 is typically configured to emit wireless signals and is therefore also referred to as a CSI transmitter. An example of the transmitter 110 is a commercially available Wi-Fi transmitting device, such as a commercial wireless router, a home wireless router, a portable router, or a wireless network card, etc. The wireless signals emitted by the transmitter 110 propagate within a building region or a region-of-interest, and will fluctuate differently with the spatial structure of signal propagation region and the activities of object and person 130 in the propagation region. In FIGS. 1 and 2, the dashed-line ellipses around the transmitter 110 represent wireless signals emitted by the transmitter 110.

The wireless signals may be received by the receiver 120. The receiver 120 is typically any suitable CSI sensor, such as a sensing antenna, a dedicated sensing antenna, a dedicated data acquisition card, and the like. On one hand, the receiver 120 collects the wireless signals, and on the other hand, it collects and records fluctuations of the wireless signals caused by the activities of the object and person 130 in the propagation space of the wireless signals.

In the illustrated embodiment, the receiver 120 communicates with a server 140 through a network 150, and it is capable of transmitting the signals and fluctuations collected and recorded to the server 140 for processing. However, it is easy to understand that the receiver 120 itself may also have the ability to process wireless signals and fluctuations, and the server 140 and the network 150 may not be provided in some embodiments.

In addition, there is a known correlation between fluctuations in the signals caused by the activities of the object and person 130 in the propagation region and the appearance and actions of the person 130. That is to say, when the person 130 appears in the signal propagation region, the wireless signals received by the receiver 120 will have certain fluctuations, and when the person 130 makes different actions in the signal propagation region (for example, standing, sitting down, walking, etc.), the wireless signals received by the receiver 120 will have also different fluctuations. By analyzing these fluctuations, it is possible to judge whether there is a person in the signal propagation region and what action the person is making Such information is critical for smart buildings. For example, it can be judged by the presence of person that an undesired entrant appears in the signal propagation region, or it can be judged that whether further operations have to be provided in the signal propagation region based on the presence of person in the signal propagation region and his/her actions, such as turning on a lighting device, playing specific sounds, etc.

For clarity, only a single transmitter 110 and a single receiver 120 are shown in FIG. 1. However, it is easy to understand that the wireless sensing device may include several transmitters 110 and several receivers 120, and these transmitters and receivers are deployed at different positions in the propagation region so that they can form different spatial structures and topology structures.

FIG. 2 is a schematic structural view of an embodiment of a deployment system for a wireless sensing device according to the present application when used in combination with the wireless sensing device shown in FIG. 1. The receiver 120 is connected to the server 140 through the network 150. The deployment system for the wireless sensing device 100 according to the present application includes: a spatial structure information obtaining module 1401, a wireless sensing device calculating module 1402, a signal strength planning module 1403, a model optimizing module 1404, and a deploying module 1405.

The spatial structure information obtaining module 1401 is configured to obtain spatial structure information of a region to be deployed. In the illustrated embodiment, the spatial structure information collecting module 1401 is in communication with a spatial structure information database 1410. The spatial structure information database 1410 may typically be a BIM model or building structure data software (for example, commercially available MagicPlan software). The spatial structure information of the region to be deployed may be any known data structure or a universal structure format file, and the spatial structure information of the region to be deployed typically includes information about the internal structure of the building. In addition, the deployment system for a wireless sensing device according to the present application may also select a calculating model and a neural network data model for other modules according to the spatial structure information of the region to be deployed.

The term “region to be deployed” referred to herein indicates a region covered by the wireless signals transmitted from the transmitter 110, that is, a region where the receiver 120 is located. In addition, the “region-of-interest” mentioned below usually coincides with or is part of the region to be deployed.

The wireless sensing device calculating module 1402 is configured to calculate a layout of the wireless sensing device. Calculating the layout of the wireless sensing device includes: setting and/or calculating a position of the transmitter 110, a position of the region-of-interest (ROI), and a position of the receiver 120. The wireless sensing device calculating module 1402 may be configured to perform calculations automatically, or to carry out the layout of the transmitter 110, the receiver 120, and the region-of-interest according to the spatial structure information of the region to be deployed, or to select a layout scheme closest or most similar to the spatial structure information of the region to be deployed from known layout schemes, or may be configured to manually set one or more of the transmitter 110, the receiver 120, and/or the region-of-interest by a user. In the last case, the wireless sensing device calculating module 1402 may also be connected to an input device and a display output device, so that the user can input and the calculation result can be displayed to the user.

The signal strength planning module 1403 is configured to calculate a signal strength and judge whether the signal strength meets the requirements. For example, the signal strength planning module 1403 may be configured to calculate a wireless signal strength in the region-of-interest according to a calculating model and the positions of the transmitter 110 and the receiver 120. The signal strength planning module 1403 may communicate with a calculating model database 1420 to store data. The method for calculating the wireless signal strength is known, and the specific algorithm and details thereof will not be described in detail herein. The goal of the signal strength planning module 1403 is to ensure that the wireless signal strength in the region-of-interest exceeds a predetermined threshold so as to guarantee the accuracy of the detection result.

In an embodiment, if the calculation result of the signal strength planning module 1403 shows that the wireless signal strength in the region-of-interest fails to reach the predetermined threshold, the positions of the transmitter 110, the receiver 120, and/or the region-of-interest need to be reconsidered. In this case, it is possible to use the wireless sensing device calculating module 1402 again to configure or calculate the positions of one or more of the transmitter 110, the receiver 120, and/or the region-of-interest, or select another layout scheme, or the user may adjust the positions of one or more of the transmitter 110, the receiver 120 and/or the region-of-interest on the site, and enter new positions.

The model optimizing module 1404 is configured to optimize a pre-trained neural network model through transfer learning according to on-site data of the wireless sensing device. For example, the on-site data includes wireless signals in the region-of-interest received by the receiver 120 and their fluctuations, and the neural network model includes a neural network model that detects a person's activities based on Wi-Fi signals. The pre-trained neural network model is typically a neural network model that has been trained according to a specific usage environment, and is stored in a neural network model database 1430. The model optimizing module 1404 communicates with the neural network model database 1430 to access data. Similarly, the model optimizing module 1404 also selects a corresponding neural network model according to the spatial structure information of the region to be deployed mentioned above, or selects a neural network model that is closest in structure and characteristics.

In an embodiment, the neural network model is a neural network model based on a convolutional neural network (CNN) or an improved model thereof. The model optimizing module 1404 may use an existing convolutional neural network model to initialize an on-site model of a specific region-of-interest, such as using parameters of a classifier of a convolutional layer, a pooling layer, and/or an output layer of the convolutional neural network model, e.g., the number of network layers, the number of subcarriers, the convolution kernel, and the like. In addition, the model optimizing module 1404 extracts characteristics from the signals of on-site data of the wireless sensing device and uses the characteristics as input for on-site optimization, thereby training or optimizing a convolutional neural network model suitable for a specific region-of-interest quickly. In addition, the optimization operation may also be performed on other artificial intelligence models known or to be developed in the art, and is not limited to the specific operation details described above.

Therefore, the model optimizing module 1404 according to an embodiment of the present application implements rapid training of the convolutional neural network model through transfer learning. The principle of the above transfer learning is that CSI signal characteristics abstracted by the first several layers of the neural network model are largely independent of the problem learned.

In addition, the model optimizing module 1404 may also be further configured to test on-site data from the wireless sensing device with a default neural network model. If the default neural network model can meet the sensing requirements of the region-of-interest, there is no need to perform the training process of the new model described above, and the default neural network model is directly deployed.

The deploying module 1405 is configured to deploy the neural network model optimized for the specific region-of-interest into the wireless sensing device. For example, the optimized neural network model may be deployed on the server 140 or directly on the receiver 120. In addition, the deploying module 1405 may also store the optimized neural network model in the neural network model database 1430 so that the optimized neural network model can be used in subsequent deployment operations of other wireless sensing devices, which can reduce potential computing requirements of the subsequent deployment operations, thereby increasing deployment efficiency and reducing costs.

Although the spatial structure information database 1410, the calculating model database 1420 and the neural network model database 1430 are shown as parts of the server 140 in the illustrated embodiment, it is easy to understand that the spatial structure information database 1410, the calculating model database 1420 and the neural network model database 1430 may also be provided as remote servers, or any other suitable data sources.

Although the spatial structure information obtaining module 1401, the wireless sensing device calculating module 1402, the signal strength planning module 1403, the model optimizing module 1404 and the deploying module 1405 are deployed on the server 140 in the illustrated embodiment, the above modules may also be deployed on different devices according to actual requirements, such as performing calculations on the receiver of the wireless sensing device or on a handheld device. Therefore, the receiver of the wireless sensing device and/or the handheld device may be correspondingly provided with a processor, an input device, a display device, and the like. In an embodiment, the handheld device may be a smartphone or a tablet computer with specific applications installed, so that the user can perform on-site operations.

In the illustrated embodiment, the server 140 operates as a cloud server. Therefore, when the user deploys the wireless sensing devices in different regions, they can be connected to the server 140 through any suitable wireless network or wired network, and the server 140 performs parameter selection, model selection and model training in the cloud so that convenient and rapid deployment of the wireless sensing system is achieved and the need for on-site calculations and operations is reduced.

FIG. 3 is a flowchart of an embodiment of a deployment method for a wireless sensing device according to the present application. The deployment method for a wireless sensing device according to an embodiment of the present application includes the following steps:

S1: obtaining spatial structure information of a region to be deployed;

S2: calculating a layout of the wireless sensing device;

S3: calculating a signal strength, and judging whether the signal strength meets requirements;

S4: optimizing a pre-trained neural network model through transfer learning according to on-site data of the wireless sensing device; and

S5: deploying the optimized neural network model into the wireless sensing device.

Specifically, in step S1, the spatial structure information of the region to be deployed is obtained from a BIM model or building structure data software (for example, commercially available MagicPlan software). In addition, the spatial structure information of the region to be deployed may also be used in subsequent steps to select a computing model and a neural network data model.

In step S2, the layout of the wireless sensing device includes the positions of the transmitter, the receiver, and the region-of-interest. The positions of the above described various components and regions may be set manually by the user. In addition, it is also possible to select the most suitable or closest layout scheme from the existing layout schemes according to the spatial structure information of the region to be deployed. The selection of the specific scheme can be made by the server or manually by the user. If the selection is manually made by the user, data can be input through an input device, and the selected result is displayed on a display device.

In step S3, the wireless signal strength in the region-of-interest is calculated according to a calculating model and the positions of the transmitter and receiver determined in the above step. If the calculated wireless signal strength fails to reach a predetermined threshold, then the process returns to the previous step to re-calculate or re-arrange the positions of the transmitter, the receiver, and the region-of-interest. The re-arranging operation may be performed by the user on the site and the user may input, and the re-calculating operation may be performed by the server to select a new layout scheme.

In step S4, the server may communicate with a database storing a series of neural network models, wherein a universal neural network model and/or an optimized neural network model are stored in the database. The server may select the most suitable or closest nerve network model according to the spatial structure information of the region to be deployed determined in step S1 and the positions of the transmitter, the receiver, and region-of-interest determined in step S2.

The neural network model includes a neural network model for detecting a person's activities based on Wi-Fi signals.

Optionally, in step S4, the on-site data from the wireless sensing device may be firstly tested with the default neural network model. The default neural network model is usually a universal model, and in some cases, the default neural network model may be suitable for the sensing requirements of the region-of-interest. No further optimization is required in such cases. In some other cases, the default neural network model cannot meet the sensing requirements of specific regions-of-interest, and then the optimization operation described below will be performed.

The optimization operation of the neural network model may be performed through transfer learning. Specifically, parameters in the selected neural network model are applied to initialize the model to be optimized. For example, the neural network model may include a convolutional neural network (CNN) model and an improved model thereof. The parameters of a classifier of a convolutional layer, a pooling layer, and/or an output layer of the convolutional neural network model, e.g., the number of network layers, the number of subcarriers, the convolution kernel, and the like, may be applied to initialize the model to be optimized. The signal characteristics of the on-site data of the wireless sensing device may be used as input in the optimization of the convolutional neural network model after extraction, thereby performing the optimization operation. In addition, the optimization operation may also be performed with other methods or approaches known or to be developed in the art, or performed on other artificial intelligence models known or to be developed in the art, and is not limited to specific operation details described above.

Step S5 optionally further includes storing the optimized neural network model in a database so as to use the neural network model for subsequent deployment operations on other wireless sensing devices, thereby effectively improving the reusability of the neural network model, and reducing the possibility of repeatedly training the neural network model.

Each of the above steps may be executed by one of the following platforms: a server, a receiver of a wireless sensing device, and a handheld device. In the illustrated embodiment, each step is executed on a server located in the cloud. However, it is easy to understand that one or more of the above steps may also be executed on other platforms, including but not limited to a receiver of a wireless sensing device and a handheld device of a user, etc. Therefore, the receiver of the wireless sensing device and/or the handheld device may be correspondingly provided with a processor, an input device, a display device, and the like.

In addition, the deployment method and deployment system for a wireless sensing device according to the present application may further include a function of user login, and an optimized neural network model may be stored under a specific user's name, thereby ensuring privacy of the user. In this case, the server 140 may also provide services such as user registration, user login, and user logout, and includes a corresponding user database.

The deployment method and deployment system for a wireless sensing device according to the present application may further include an operation of connecting the receiver 120 to the wireless network of the transmitter 110 and to a corresponding wireless network access module. Accordingly, the server, the receiver of the wireless sensing device and/or the handheld device can provide corresponding network access functions.

The deployment method and deployment system for a wireless sensing device according to the present application can be used to quickly deploy a Wi-Fi-based person sensing system inside a building, thereby sensing the presence of a person in a region-of-interest inside the building, and potentially classifying the person's specific actions. This information can be used for decision making by other management and control systems of the building. For example, in the case of an unauthorized intruder in the region-of-interest, the security system may be warned of the intruder. For another example, in case of appearance or no appearance of person in the region-of-interest, devices such as an air conditioning system and a lighting system may be turned on or turned off accordingly, thereby improving the user experience of person inside the building.

In addition, by adopting the deployment method and deployment system for a wireless sensing device according to the present application, the deployment efficiency of the wireless sensing system can be improved, and on-site commissioning and optimizing operations can be reduced.

The present application has been disclosed herein with reference to the accompanying drawings, and those skilled in the art are also enabled to implement the present application, including manufacturing and using any device or system, selecting suitable materials, and using any combined method. The scope of the present application is defined by the claimed technical solutions, and contains other examples that can be conceived by those skilled in the art. Such other examples should be considered as falling within the scope of protection determined by the technical solutions claimed in the present application, as long as such other examples include structural elements that are not different from the literal language of the claimed technical solutions, or such other examples include equivalent structural elements that are not substantively different from the literal language of the claimed technical solutions.

What is claimed is:

1. A deployment method for a wireless sensing device characterized in that it comprises the following steps:
S1: obtaining spatial structure information of a region to be deployed;
S2: calculating a layout of the wireless sensing device;
S3: calculating a signal strength according to the layout, and judging whether the signal strength meets requirements;
S4: judging whether a default neural network model meets the requirements according to signals received by the wireless sensing device; and if the requirements are not met, optimizing a pre-trained neural network model through transfer learning according to the signals received by the wireless sensing device; and
S5: deploying the optimized neural network model into the wireless sensing device.

2. The deployment method according to claim 1, wherein in step S1, the spatial structure information of the region to be deployed is obtained from a BIM model or building structure data software.

3. The deployment method according to claim 1, wherein the wireless sensing device comprises a transmitter and a receiver; and in step S2, the layout of the wireless sensing device comprises a position of the transmitter, a position of the receiver, and a position of a region-of-interest.

4. The deployment method according to claim 3, wherein in step S3, a wireless signal strength in the region-of-interest is calculated according to a calculating model and the positions of the transmitter and the receiver.

5. The deployment method according to claim 1, wherein in step S4, the neural network model comprises a convolutional neural network model for detecting a person's activities based on Wi-Fi signals, and signal characteristics received by the wireless sensing device are used as an input in the optimization of the convolutional neural network model.

6. The deployment method according to claim 1, wherein each step is executed by one of the following platforms: a server, a receiver of the wireless sensing device, and a handheld device.

7. A deployment system for a wireless sensing device characterized in that it comprises:
a spatial structure information obtaining module configured to obtain spatial structure information of a region to be deployed;
a wireless sensing device calculating module configured to calculate a layout of the wireless sensing device;
a signal strength planning module configured to calculate a signal strength according to the layout, and judge whether the signal strength meets requirements;
a model optimizing module configured to judge whether a default neural network model meets the requirements according to signals received by the wireless sensing device; and if the requirements are not met, optimize a pre-trained neural network model through transfer learning according to the signals received by the wireless sensing device; and
a deploying module configured to deploy the optimized neural network model into the wireless sensing device.

8. The deployment system according to claim 7, wherein the spatial structure information obtaining module is configured to obtain the spatial structure information of the region to be deployed from a BIM model or building structure data software.

9. The deployment system according to claim 7, wherein the wireless sensing device comprises a transmitter and a receiver, and calculating the layout of the wireless sensing device comprises: setting and/or calculating a position of the transmitter, a position of a region-of-interest, and a position of the receiver.

10. The deployment system according to claim 9, wherein calculating the signal strength comprises calculating a wireless signal strength in the region-of-interest according to a calculating model and the positions of the transmitter and the receiver.

11. The deployment system according to claim 7, wherein the neural network model comprises a convolutional neural network model that detects a person's activities based on Wi-Fi signals, and signal characteristics received by the wireless sensing device are used as an input in the optimization of the convolutional neural network model.

12. The deployment system according to claim 7, wherein the spatial structure information obtaining module, the wireless sensing device calculating module, the signal strength planning module, the model optimizing module, and the deploying module are deployed on one or more of the followings: a server, a receiver of the wireless sensing device, and a handheld device.
